(19) United States
(12) Patent Application Publication
(10) Pub. No.: US 2023/0149812 A1
(43) Pub. Date: May 18, 2023

(54) Methods and Systems for Developing Video Games Terrain Systems

(71) Applicant: Activision Publishing, Inc., Santa Monica, CA (US)

(72) Inventors: John Thomas Hooker, Redondo Beach, CA (US); Michael Jonathan Uhlik, Austin, TX (US); Josiah Michael Bartoszek Manson, Seattle, WA (US)

(21) Appl. No.: 18/054,726

(22) Filed: Nov. 11, 2022

Related U.S. Application Data
(60) Provisional application No. 63/264,029, filed on Nov. 12, 2021.

(51) Int. Cl. A63F 13/52; G06T 19/20

(52) U.S. Cl. CPC A63F 13/52; G06T 19/20; G06T 2219/2024

(57) ABSTRACT

This specification discloses methods and systems for generating a biome within a virtual landscape of a video game. The biome has at least two layers. The system includes a computing device programmed to execute a plurality of programmatic instructions that, when executed create a first visual layer that is defined by a set of first rules having a first set of visual characteristics and adding one or more second visual layers, where the one or more second visual layers is programmatically distinct from the first visual layer, the one or more second visual layers automatically abides by each of the set of first rules, the one or more second visual layers automatically adopts each of the first set of visual characteristics, and the biome is made of a combination of the first layer and the one or more second visual layers.

### CROSS-REFERENCE

The present application relies on U.S. Patent Provisional Application No. 63/264,029, titled “Methods and Systems for Developing Video Games Terrain Systems” and filed on Nov. 12, 2021, for priority, which is herein incorporated by reference in its entirety.

### FIELD

The present specification is related generally to the field of video games and graphics processing. More specifically the present specification is related to methods and systems that enable more efficient creation of virtual landscapes in a video game.

### BACKGROUND

In video game terminology, a biome is a collection of predefined elements that come together in layers to create a virtual landscape or, more broadly, a gamespace. Biomes are defined by a plurality of layers and a set of rules to place and/or define those layers, so as to create the virtual landscape or gamespace for a video game. The biome represents a view of a gamespace on any given playthrough. Creating and generating the biome is an important aspect of game development.

Traditional map creation systems for virtual environments, including game spaces, have been confined to small areas and are meticulously defined with details specific to the game. As a result, conventional tools for editing virtual terrains are detail oriented. Classic terrain editing tools offer functions to paint heights and layers in a terrain. However, a content creator is able to use these tools in specific patches, or small areas of the virtual space, and is required to recreate the terrain in all the different patches. These patches are then stitched together by the content creator. The foliage and any other type of coverage in a terrain are typically hand placed. The conventional tools are therefore limited in their ability to create larger spaces and landscapes with large terrain vistas that require more terrain and more foliage.

Therefore, there is a need to create and use biomes to quickly and efficiently populate a terrain with props and materials and maintain consistency between different terrains of a game space. Methods and systems are needed to provide a degree of procedural generation of clutter for large terrains that cover widespread areas or a geography. Additionally, different types of maps are required to be created for different gaming platforms and with a higher resolution. There is also a need to manage materials and layers within the terrain, accelerate the ability to sculpt and edit the terrain, and achieve these objectives with precision in different play areas when required.

Given the complexity of biomes, there is a need to enable game designers and content creators to iterate through biomes rapidly in a map editor, design biomes for extreme detail as well as large scale procedural generation and create biomes that efficiently run with a resolution of at least 60 fps.

### SUMMARY

The following embodiments and aspects thereof are described and illustrated in conjunction with systems, tools and methods, which are meant to be exemplary and illustrative, and not limiting in scope. The present application discloses numerous embodiments.

The present specification discloses a method for generating a biome within a virtual landscape of a video game, wherein the biome comprises at least two layers, wherein the method comprises: creating a first visual layer, wherein the first visual layer is defined by a set of first rules comprising a first plurality of visual characteristics; and adding one or more second visual layers, wherein each of the one or more second visual layers is programmatically distinct from the first visual layer, wherein each of the one or more second visual layers automatically abides by each of the set of first rules, wherein each of the one or more second visual layers automatically adopts each of the first plurality of visual characteristics, and wherein the biome is made of a combination of the first layer and the one or more second visual layers.

Optionally, one of the set of first rules defines a location of the first visual layer.

Optionally, one of the set of first rules defines at least one of material, height, or clutter of the first visual layer.

Optionally, each of the one or more second visual layers is defined by a set of second rules, wherein the set of second rules is based upon and includes the set of first rules, wherein the second set of rules comprises a second plurality of visual characteristics and wherein the second plurality of visual characteristics is different from, but does not contradict, the first plurality of visual characteristics. Optionally, the biome further comprises one or more third visual layers, wherein each of the one or more third visual layers is programmatically distinct from the first visual layer and the one or more second visual layers and wherein each of the one or more third visual layers automatically abides by each of the set of first rules and each of the set of second rules. Optionally, each of the one or more third visual layers automatically adopts each of the first plurality of visual characteristics and the second plurality of visual characteristics and the biome is made of a combination of the first layer, the one or more second visual layers, and the one or more third visual layers. Optionally, the method further comprises combining each of the set of first rules and each of the set of second rules using one or more functions. Optionally, the one or more functions comprises addition and/or multiplication.

Optionally, the method further comprises adjusting the first plurality of visual characteristics by performing at least one of a blurring function, an adjust brightness function and a contrast function, an invert function, or an edge detect function.

The present specification also discloses a system for generating a biome within a virtual landscape of a video game, wherein the biome comprises at least two layers, the system comprising a computing device programmed to execute a plurality of programmatic instructions that, when executed: create a first visual layer, wherein the first visual layer is defined by a set of first rules comprising a first plurality of visual characteristics; and add one or more second visual layers, wherein each of the one or more second visual layers is programmatically distinct from the first visual layer, wherein each of the one or more second visual layers automatically abides by each of the set of first rules, wherein each of the one or more second visual layers automatically adopts each of the first plurality of visual characteristics, and wherein the biome is made of a combination of the first layer and the one or more second visual layers.

Optionally, one of the set of first rules defines a location of the first visual layer.

Optionally, one of the set of first rules defines at least one of material, height, or clutter of the first visual layer.

Optionally, each of the one or more second visual layers is defined by a set of second rules, wherein the set of second rules is based upon and includes the set of first rules, wherein the second set of rules comprises a second plurality of visual characteristics and wherein the second plurality of visual characteristics is different from, but does not contradict, the first plurality of visual characteristics. Optionally, the biome further comprises one or more third visual layers, wherein each of the one or more third visual layers is programmatically distinct from the first visual layer and the one or more second visual layers and wherein each of the one or more third visual layers automatically abides by each of the set of first rules and each of the set of second rules. Optionally, each of the one or more third visual layers automatically adopts each of the first plurality of visual characteristics and the second plurality of visual characteristics and the biome is made of a combination of the first layer, the one or more second visual layers, and the one or more third visual layers. Optionally, when executed, the plurality of programmatic instructions combine each of the set of first rules and each of the set of second rules using one or more functions. Optionally, the one or more functions comprises addition and/or multiplication. Optionally, when executed, the plurality of programmatic instructions adjust the first plurality of visual characteristics by performing at least one of a blurring function, an adjust brightness function and a contrast function, an invert function, or an edge detect function. Optionally, when executed, the plurality of programmatic instructions adjust the second plurality of visual characteristics by performing at least one of a blurring function, an adjust brightness function and a contrast function, an invert function, or an edge detect function.

The aforementioned and other embodiments of the present specification shall be described in greater depth in the drawings and detailed description provided below.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is a block diagram of an embodiment of a multi-player online gaming or massively multiplayer online gaming system/environment in which the systems and methods of the present specification may be implemented or executed;

FIG. 2A is a flow diagram showing an exemplary process for generating one or more biomes for a video game, in accordance with some embodiments of the present specification;

FIG. 2B illustrates an exemplary graphical user interface (GUI) provided for adding a super terrain, in accordance with some embodiments of the present specification;

FIG. 2C illustrates an exemplary GUI presented for default setting of features of a newly generated super terrain, in accordance with some embodiments of the present specification;

FIG. 2D shows the new GUI presented upon selection of the option to rescale size and elevation parameters for the new super terrain;

FIG. 3A illustrates a top of the peaks layer using faceted noise;

FIG. 3B illustrates a side elevation view of the peaks layers using faceted noise;

FIG. 3C illustrates a top view of the peaks layer using rounded noise;

FIG. 3D illustrates a side elevation view of the peaks layer using rounded noise;

FIG. 3E illustrates a top view of the peaks layer using rounded faceted noise;

FIG. 3F illustrates a side perspective view of the peaks layer using rounded faceted noise;

FIG. 3G illustrates a top view of the peaks layer using towers;

FIG. 3H illustrates a side perspective view of the peaks layer using towers;

FIG. 3I illustrates a top perspective view of a height map illustrating multiple control points in a grid format;

FIG. 3J illustrates another view of height map of FIG. 3I where the control points have been dragged or repositioned by dragging to raise and lower certain areas of the height map;

FIG. 4A illustrates an exemplary height map of a terrain in accordance with some embodiments of the present specification;

FIG. 4B illustrates the height map of FIG. 4A after application of ‘mountain’ type of erosion;

FIG. 4C illustrates the height map of FIG. 4A after application of ‘river’ type of erosion;

FIG. 4D illustrates the height map of FIG. 4A after application of ‘valley’ type of erosion;

FIG. 4E illustrates the height map of FIG. 4A after application of ‘top soil’ type of erosion;

FIG. 5A illustrates examples of material, height and clutter layers listed for the semi-arid biome, in accordance with one embodiment of the present specification;

FIG. 5B illustrates an interface where a layer from FIG. 5A is selected to view and edit the rules associated with it, in accordance with some embodiments of the present specification; and

FIG. 6 illustrates a location in a biome where a control layer with the rule “no large clutter” is applied within an area of the biome that is otherwise filled with other types of clutter such as trees.

### DETAILED DESCRIPTION

The present specification is directed toward methods and systems that enable game developers to combine a variety of tools that help make the creation of a virtual landscape in a video game more efficient. Specifically, the tools enable the developers to define a rule system that make propagation of attributes across layers that define a biome, describe how clutter are placed in a terrain, and efficiently create blending height maps.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

The term “a multi-player online gaming environment” or “massively multiplayer online game” may be construed to mean a specific hardware architecture in which one or more servers electronically communicate with, and concurrently support game interactions with, a plurality of client devices, thereby enabling each of the client devices to simultaneously play in the same instance of the same game. Preferably the plurality of client devices number in the dozens, preferably hundreds, preferably thousands. In one embodiment, the number of concurrently supported client devices ranges from 10 to 5,000,000 and every whole number increment or range therein. Accordingly, a multi-player gaming environment or massively multi-player online game is a computer-related technology, a non-generic technological environment, and should not be abstractly considered a generic method of organizing human activity divorced from its specific technology environment.

In various embodiments, the system includes at least one processor capable of processing programmatic instructions, has a memory capable of storing programmatic instructions, and employs software comprised of a plurality of programmatic instructions for performing the processes described herein. In embodiments, a computer-readable non-transitory medium comprises the plurality of executable programmatic instructions. In one embodiment, the at least one processor is a computing device capable of receiving, executing, and transmitting a plurality of programmatic instructions stored on a volatile or non-volatile computer readable medium.

In various embodiments, a computing device includes an input/output controller, at least one communications interface and system memory. The system memory includes at least one random access memory (RAM) and at least one read-only memory (ROM). These elements are in communication with a central processing unit (CPU) to enable operation of the computing device. In various embodiments, the computing device may be a conventional standalone computer or alternatively, the functions of the computing device may be distributed across multiple computer systems and architectures.

In some embodiments, execution of a plurality of sequences of programmatic instructions or code enables or cause the CPU of the computing device to perform various functions and processes. In alternate embodiments, hard-wired circuitry may be used in place of, or in combination with, software instructions for implementation of the processes of systems and methods described in this application. Thus, the systems and methods described are not limited to any specific combination of hardware and software.

The term “module”, “application” or “engine” used in this specification may refer to computer logic utilized to provide a desired functionality, service or operation by programming or controlling a general-purpose processor. Stated differently, in some embodiments, a module, application or engine implements a plurality of instructions or programmatic code to cause a general-purpose processor to perform one or more functions. In various embodiments, a module, application or engine can be implemented in hardware, firmware, software or any combination thereof. The module, application or engine may be interchangeably used with unit, logic, logical block, component, or circuit, for example. The module, application or engine may be the minimum unit, or part thereof, which performs one or more particular functions.

The term “platform” or “target gaming platform” used in this specification may refer to hardware and/or software specifications of a player's client device (which may be a PC or a gaming console, for example). In some embodiments, “platform” may refer to at least GPU (Graphics Processing Unit) specification, CPU specification, display screen resolution, RAM and hard disk space available and a type of operating system.

The term “offline” or “offline process” used in this specification refers to one or more programmatic instructions or code that may be implemented or executed while the game is not being played by any player (that is, while the one or more game servers are not rendering a game for playing).

The term “runtime” or “runtime process” used in this specification refers to one or more programmatic instructions or code that may be implemented or executed during gameplay (that is, while the one or more game servers are rendering a game for playing).

The term “biome” as used in this specification refers to a collection of predefined elements that are integrated into layers to create a virtual landscape of a game space. Using and making biomes is a way to quickly populate a superterrain with props, textures, objects, and materials and maintain consistency between superterrains. Biomes may be defined by materials, heights, and clutter layers. The term “biome set” used in this specification refers to a collection of biomes. A simple biome set may consist of at least one material and one biome. A more complex biome set may have up to 31 materials, many clutter layers, and many biomes.

The term “clutter” used in this specification refers to various landscape elements that are spread over a terrain. Examples of landscape elements that are often cluttered over a terrain may include, and are not limited to, rocks, trees, snow, and bushes.

### OVERVIEW

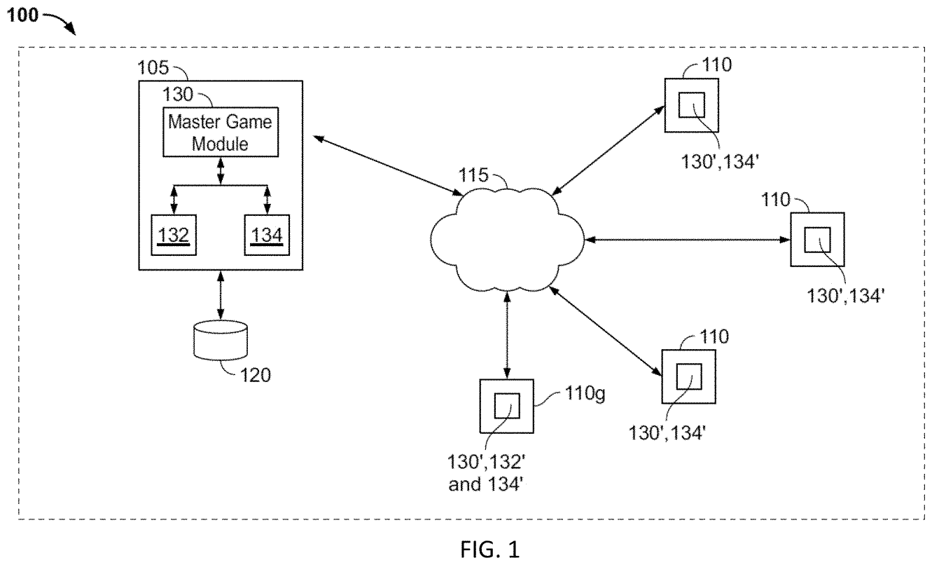

FIG. 1 illustrates an embodiment of a multi-player online gaming or massively multiplayer online gaming system/environment 100 in which the systems and methods of the present specification may be implemented or executed. The system 100 comprises client-server architecture, where one or more game servers 105 are in communication with one or more client devices 110 over a network 115. Players and non-players, such as computer graphics artists or designers, may access the system 100 via the one or more client devices 110. The client devices 110 comprise computing devices such as, but not limited to, personal or desktop computers, laptops, Netbooks, handheld devices such as smartphones, tablets, and PDAs, gaming consoles and/or any other computing platform known to persons of ordinary skill in the art. Although three client devices 110 are illustrated in FIG. 1, any number of client devices 110 can be in communication with the one or more game servers 105 over the network 115.

The one or more game servers 105 can be any computing device having one or more processors and one or more computer-readable storage media such as RAM, hard disk or any other optical or magnetic media. The one or more game servers 105 include a plurality of modules operating to provide or implement a plurality of functional, operational or service-oriented methods of the present specification. In some embodiments, the one or more game servers 105 include or are in communication with at least one database system 120. The database system 120 stores a plurality of game data including data representative of one or more biomes associated with at least one game that is served or provided to the client devices 110 over the network 115. In some embodiments, the one or more game servers 105 may be implemented by a cloud of computing platforms operating together as game servers 105.

In accordance with aspects of the present specification, the one or more game servers 105 provide or implement a plurality of modules or engines such as, but not limited to, a master game module 130, a game development module 132, and a rendering module 134. In some embodiments, the one or more client devices 110 are configured to implement or execute one or more of a plurality of client-side modules some of which are same as or similar to the modules of the one or more game servers 105. For example, in some embodiments each of the player client devices 110 executes a client-side game module 130′ (also referred to as—client game module 130′) that integrates a client-side rendering module 134′ (also referred to as—client rendering module 134′) while at least one non-player client device 110g executes the client game module 130′ that integrates a client-side game development module 132′ (also referred to as—client game development module 132′) and the client rendering module 134′.

In some embodiments, the at least one non-player client device 110g does not include the client game development module 132′. Instead, the non-player client device 110g is used by the computer graphics artist or designer to log into the one or more game servers 105 and execute the game development module 132 on the server to generate gaming elements, offline. The game elements, such as biomes used in the gaming environment, developed by the non-player client device 110g, are stored in the at least one database 120.

In some embodiments, the one or more game servers 105 do not implement the game development module 132. Instead, the game development module 132 is implemented on the non-player client device 110g wherein the game developer, computer graphics artist, or designer execute the game development module 132 on the server. The game elements developed through the non-player client device 110g are then uploaded, via the network 115, and stored in the at least one database 120.

While various aspects of the present specification are being described with reference to functionalities or programming distributed across multiple modules or engines 132 and 134, it should be appreciated that, in some embodiments, some or all of the functionalities or programming associated with these modules or engines may be integrated within fewer modules or in a single module—such as, for example, in the master game module 130 itself on the server side and in the client gaming module 130′ on the client side.

In embodiments, the master game module 130 is configured to execute an instance of an online game to facilitate interaction of the players with the game. In embodiments, the instance of the game executed may be synchronous, asynchronous, and/or semi-synchronous. The master game module 130 controls aspects of the game for all players and receives and processes each player's input in the game. In other words, the master game module 130 hosts the online game for all players, receives game data from the client devices 110 and transmits updates to all client devices 110 based on the received game data so that the game, on each of the client devices 110, represents the most updated or current status with reference to interactions of all players with the game. Thus, the master game module 130 transmits game data over the network 115 to the client devices 110 for use and rendering by the game module 130′ to provide local versions and current status of the game to the players.

On the client-side, each of the one or more player client devices 110 implements the game module 130′ that operates as a gaming application to provide a player with an interface between the player and the game. The game module 130′ generates the interface to render a virtual environment, virtual space or virtual world associated with the game and enables the player to interact in the virtual environment to perform a plurality of game and other tasks and objectives. The game module 130′ accesses game data received from the game server 105 to provide an accurate representation of the game to the player. The game module 130′ captures and processes player inputs and interactions within the virtual world or environment and provides updates to the game server 110 over the network 115.

In embodiments, the game module 130′ (for each of the one or more player client devices 110) also integrates the client rendering module 134′ that, in data communication with the server-side rendering module 134, performs a plurality of tasks (during runtime or execution of gameplay) such as: a) determining which representation of the game space to render for a given gameplay view or scene, b) assessing a player's client device configurations and platform specifications such as, but not limited to, display screen resolution, GPU capabilities and memory availability, c) monitoring network (for example, Internet) connectivity or streaming bandwidth fluctuations, GPU workload and performance parameters (such as, for example, frame latency), memory usage and the player's field of view (FOV) changes, and d) dynamically applying one or more of a plurality of corrective factors to offline authored virtual landscapes, wherein the one or more of a plurality of corrective factors include factors such as FOV scaling, screen resolution scaling, vertex processing efficiency scaling, general processing unit (GPU) performance scaling and memory budget-based biasing.

In embodiments, the at least one client device 110g is configured as a non-player computing device to enable a game developer, graphics artist, or designer to interact with the one or more game servers 105. In embodiments, the at least one client device 110g also implements the client game module 130′ that, in some embodiments, further integrates the client game development module 132′ and the client rendering module 134′. In accordance with some aspects of the present specification, an offline execution of the client game development module 132′, in data communication with the server-side game development module 132, enables generation of one or more biomes. The offline execution of the client game development module 132′, in data communication with the server-side game development module 132, further results in generating one or more GUIs (graphical user interfaces) to enable the game developer, graphics designer, or artist to optimize and modify one or more of the biomes for use in the game space.

The database system 120 described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database system 120 may comprise one or more such databases that reside in one or more physical devices and in one or more physical locations.

During runtime, when the video game is actively played by one or more players, rendering module 134 implements a plurality of instructions or programmatic code to render the plurality of representations or versions of biomes in the virtual landscape as required during playthrough.

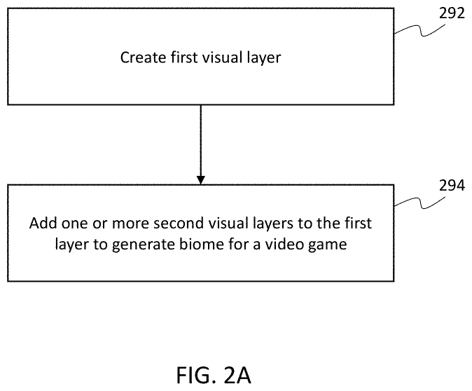

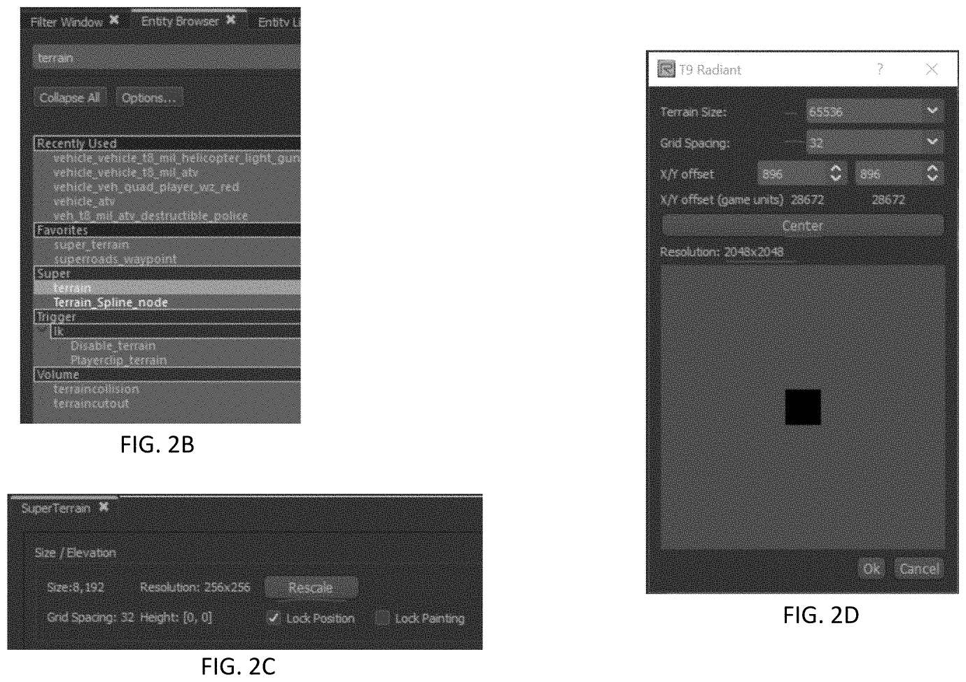

FIG. 2A illustrates an exemplary process for generating one or more biomes for a video game, in accordance with some embodiments of the present specification. The biome can be generated within a virtual landscape of a video game. The biome is generated using layers of different types of terrains, landscapes, or any other types of elements that can be contained in a biome. Accordingly, at step 292, a first visual layer is created using the modules described earlier in FIG. 1. The first visual layer is defined by a first set of rules comprising a first plurality of visual characteristics. At step 294, one or more second or subsequent visual layers can be added. The subsequent visual layers are programmatically distinct from the first visual layer. The rules for each subsequent layer adopt and/or are a subset of the rules of the first visual layer. As a result, each of the one or more second visual layers automatically abides by each of the first set of rules. Additionally, the subsequent layers may reference rules defined for each other, such that one or more rules of a layer A may be applied to a layer B, where both layers A and B are built upon the first set of rules of a control layer or base layer. The biome is therefore made of a combination of the first layer and the subsequent one or more second visual layers. The subsequent layers are governed by their corresponding set of rules that include the corresponding visual characteristics such that the subsequent visual characteristics are different from, but do not contradict, the first set of visual characteristics of the first visual layer. The various types of layers are now described in detail.

Super Terrain

A super terrain refers to a piece of land or a geographic area that forms the ground for a game space. The super terrain provides the foundation over which one or more biomes can be generated or may be the visual result of one or more biomes. One or more materials, clutter layers, and heights can also be added over the super terrain. A developer can create a super terrain by first creating a test map or a new scene. In the platform provided by the embodiments of the present specification, using game development module 132/132′, a graphical user interface (GUI) is presented to the developer that enables adding a super terrain entity within the game space. FIG. 2A illustrates an exemplary GUI provided for adding a super terrain, in accordance with some embodiments of the present specification. Adding the super terrain presents a variety of options that can be used to describe the basic features of the new super terrain. FIG. 2B illustrates an exemplary GUI presented for default setting of features of a newly generated super terrain, in accordance with some embodiments of the present specification. As illustrated, a default setting shows size/elevation setting with a predefined size, resolution, grid spacing, and height. The interface also provides an option to rescale the super terrain, providing an ability to change the size and elevation settings. Selecting the option to rescale generates another GUI, which is shown in FIG. 2C, in accordance with some embodiments of the present specification. FIG. 2C shows the new GUI presented upon selection of the option to rescale size and elevation parameters for the new super terrain. The GUI of FIG. 2C allows the developer to define values for parameters such as, and not limited to, terrain size, grid spacing, X/Y offset (position), of the terrain. In one embodiment, play space of the video game is added with a super terrain defined by a predefined number of quads units. These parameters make each terrain have a predefined resolution level.

In addition to the size and elevation parameters, the newly created super terrain may have additional default parameters, such as and not limited to, those relating to layers for height, spline, and material. Developers are provided with the option to update the corresponding parameters for these layers, as required. Once the parameters are defined, or continues as default, the super terrain is ready for sculpting. Some of the methods provided by the embodiments of the present specification that enable sculpting of the super terrain include, and are not limited to, importing a height map, adding modifier layers, adding erosion layers, and hand painting details.

The developer is further provided with an option to import a height map layer through the GUI. A location of a previously stored height map is elected for import. In some embodiments, default height map layer settings are selected, unless selected otherwise by the developer. Parameters of the selected height layer may then be set, which include scale, offset, position, size and rotation. The scale setting determines the altitude of white value in the height map. The scale may be set in inches. The offset value changes the value of the whole height map of the terrain up or down. Position, size, and rotation allow manipulating the position, scale, and orientation of the height map on the terrain.

A modifier layer is a layer that is added above the layer that is desired to be modified by the developer. In some embodiments, the modifier layer may be one of at least eight types. One of the modifier layers is copy layer, which enables copying of an element of the height map on a terrain into another location. The copied element may be blended in its new location with tools that enable its blending, such as for example an option to “Edge Fade” that fades edges of the copied element to help it blend in its location. Additionally, options are provided to set the copied data to override or be additive to the heightmap underneath.

Another modifier layer is a noise layer which may be adjusted with parameters such as ‘scale’ to adjust the size of the noise, and ‘detail’ to break up the scale further. Yet another modifier layer is a distort layer which is defined with settings including: ‘amount’ which determines how much distortion is applied to the heightmap, ‘scale’ which determines the size of the distortion, ‘detail’ which breaks up the distortion with noise, and ‘seed’ which randomizes the distortion.

Yet one more modifier layer is a smooth layer that may be defined by a ‘smooth amount’ that acts as a simple blur layer to the height map. One more modifier layer is a levels layer where: ‘Source Min’ and ‘Source Max’ may be defined for the levels layer as elevation values. Similarly, ‘Result Min’ and ‘Result Max’ are also adjusted.

Yet another modifier layer is a hills and valleys layer which adds random hills and valleys to the height map. Adjustable parameters for this layer may include ‘count’ for the number of hills and valleys, ‘Max size’ which limits the maximum size of each hill or valley, ‘Min size %’ which is provided as a percentage of the ‘max size’, ‘sharpness’ that defines how conical or spherical the gaussian dot is on the height map, and ‘seed’ which randomizes the location of the hills and valleys. Another modifier layer may be a peaks layer that adds cellular noise to create the appearance of geometric peaks on the height map. The peaks layer ‘scale’ may be adjusted to increase the height, and ‘number of peaks’ increases or decreases the intensity of the noise pattern.

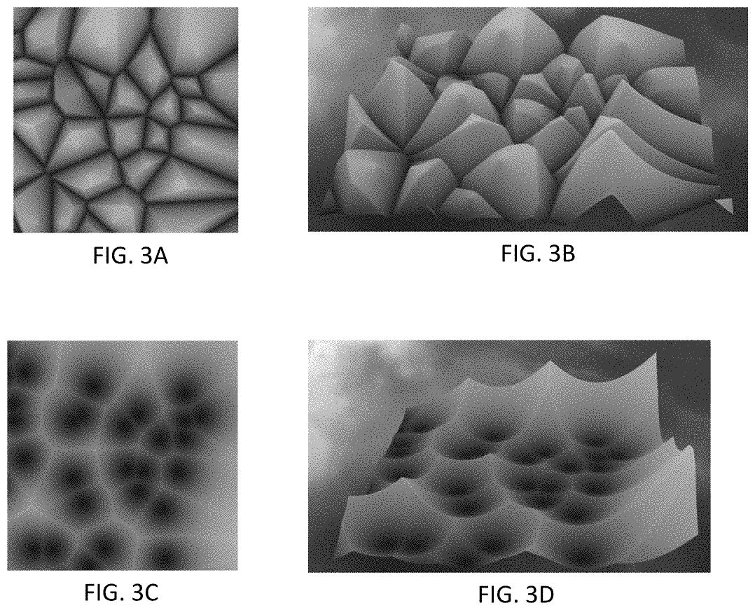

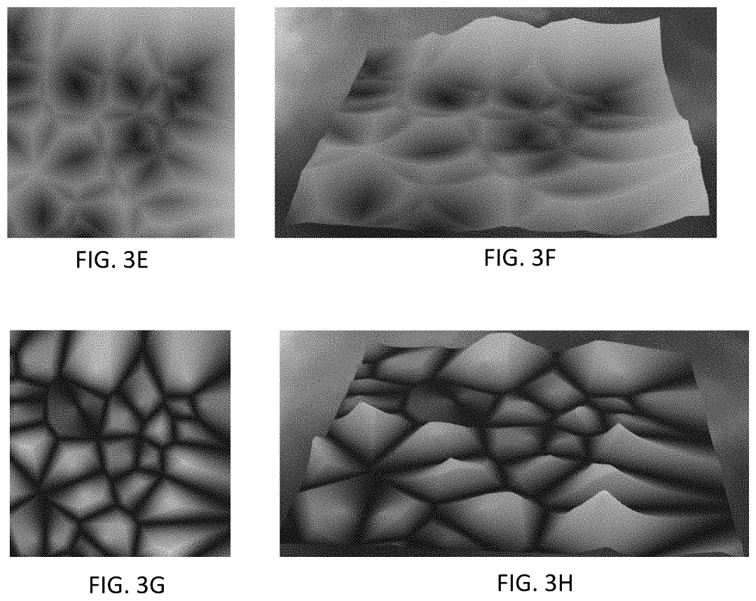

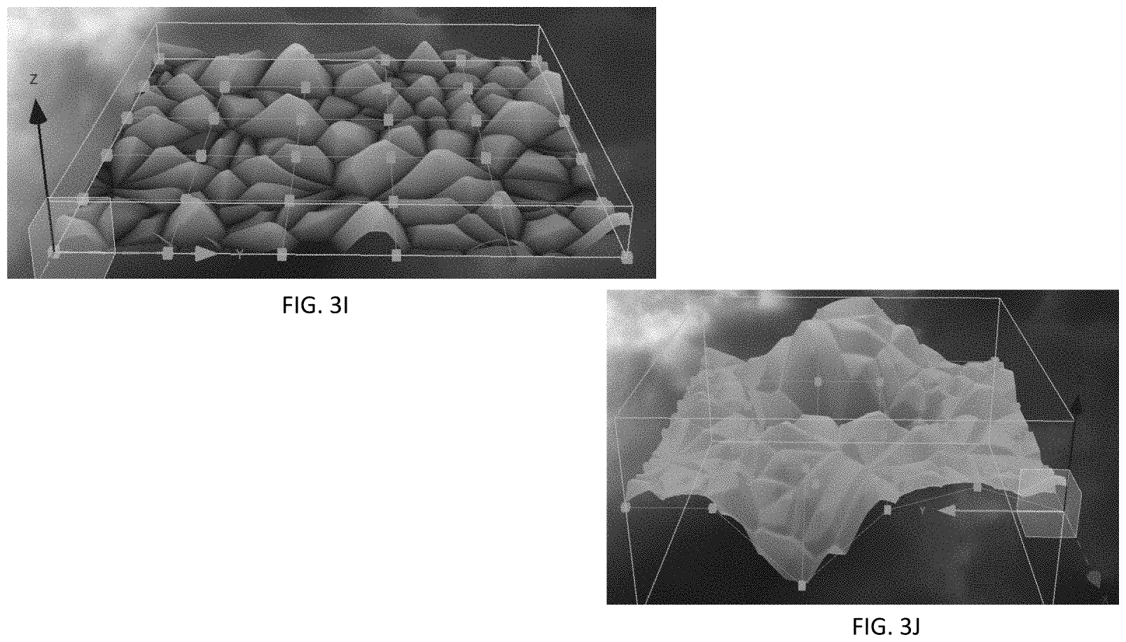

In some embodiments, four types of noise may be introduced in the peaks layer. FIG. 3A illustrates a top of the peaks layer using faceted noise. FIG. 3B illustrates a side elevation view of the peaks layer of FIG. 3A using faceted noise. FIG. 3C illustrates a top view of the peaks layer using rounded noise. FIG. 3D illustrates a side elevation view of the peaks layer of FIG. 3C using rounded noise. FIG. 3E illustrates a top view of the peaks layer using rounded faceted noise. FIG. 3F illustrates a side perspective view of the peaks layer of FIG. 3E using rounded faceted noise. FIG. 3G illustrates a top view of the peaks layer using towers. FIG. 3H illustrates a side perspective view of the peaks layer of FIG. 3G using towers.

A modifier layer called surface layer adds control points to the terrain to enable raising and lowering specific areas of the height map. Adjustable parameters for the surface layer include ‘control points’ to increase or decrease the number of control points. FIG. 3I illustrates a top perspective view of a height map illustrating multiple control points in a grid format. FIG. 3J is another view of height map of FIG. 3I where the control points have been dragged or repositioned by dragging to raise and lower certain areas of the height map.

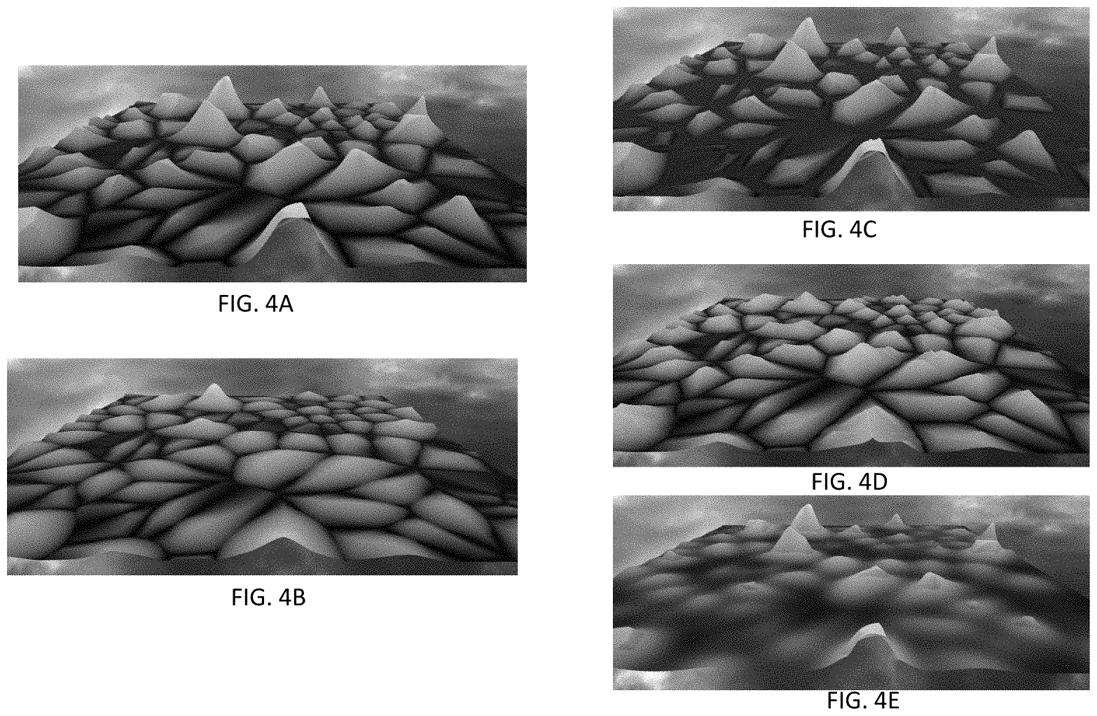

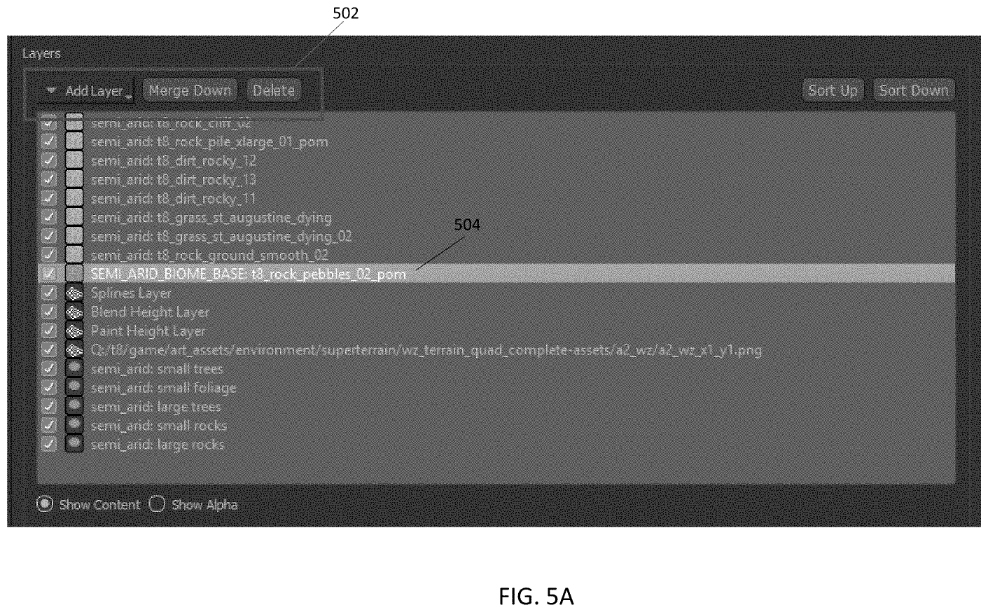

In addition to modifier layers, the super terrain may include erosion layers. An erosion layer may erode the terrain height map based on different types of erosion styles. FIG. 4A illustrates an exemplary height map of a terrain in accordance with some embodiments of the present specification. Once an erosion layer is added, a type of erosion may be selected. Some embodiments of types of erosion include: ‘mountain’ which sheers steep slopes in the terrain, ‘river’ that carves narrow channels in the terrain, ‘valley’ which simulates a full geological system, and ‘top soil’ that drops a layer of eroded sediment on the terrain. FIG. 4B illustrates the height map of FIG. 4A after application of ‘mountain’ type of erosion. FIG. 4C illustrates the height map of FIG. 4A after application of ‘river’ type of erosion. FIG. 4D illustrates the height map of FIG. 4A after application of ‘valley’ type of erosion. FIG. 4E illustrates the height map of FIG. 4A after application of ‘top soil’ type of erosion. Parameters of the different types of erosion can be adjusted, and include ‘strength’ of the erosion, ‘threshold’ of the erosion, ‘iterations’ which indicate an amount of time the erosion has been going (reruns the strength and threshold multiple times), ‘smooth’ that acts as blur to the height map, and ‘offset’ that raises or lowers the height map.

Further, the appearance of the super terrain may be sculpted using hand paint details. A paint height layer can be used to hand paint height data as desired. A painting tool is used through a GUI to perform the painting. The painting tool may be defined by adjustable parameters such as, and not limited to, softness to adjust the feathering of the paint brush, size to adjust the size of the brush, and strength to adjust the intensity of the brush. The paint tool may further be used in one of multiple modes such as paint, smooth, smudge, flatten, noise, clone, clay, set, and pick stamp. Paint can be the default paint mode. The paint mode either enables painting in textures, models, height, or alpha values depending on the layer that is selected. Smooth mode smooths out rough terrain. The smooth mode can be used for creating smooth rolling hills. This mode can smooth alpha as well, which can be useful for material/clutter/blending layers. The smudge mode allows the developer to grab areas that have a texture or clutter values painted onto them and smudge it using the Paint Tool. If the area of terrain that is used as a starting point has 0% alpha this tool has no effect. The flatten mode flattens out terrain based on where the painting is started. This mode only works on height layers. The noise mode allows the use of the paint tool to randomize height and alpha values. The clone mode is used to paint in a copy of a sampled terrain and its height data or alpha information. The clay mode is similar to the smudge tool, but is used on the terrain's height information. The set mode enables flattening out terrain based on sampled or typed height values. The pick stamp mode, like a brush, lets the developer determine the shape of the brush used for painting. Additionally, any black and white image may be imported using this mode.

Biome Generation

Embodiments of the present specification provide tools that enable the game developer to define multiple rules that can drive how a biome is generated for a given game space. One or more layers are tagged as ‘control’ layers, also termed herein as ‘alpha’ layers or ‘base’ layers. Subsequently one or more layers are added upon the control layer. Each layer is based on a set of rules. Rules are defined by the game development module 132/132′, which lay a foundation of the control layer and the subsequent layers. Rules can be defined so that they are applicable to the subsequent layers that are built upon the control layer and any other layer other than the control layer. In some embodiments, the rules defining the control layer are selectively and optionally passed on to the one or more layers that are built upon the control layer. Rules for one or more additional layers that are built upon the control layer can be referred from non-control layers as well. In embodiments, all layers that make up a biome are constrained to one of the control layers, which is the ‘first layer’ (alpha layer or base layer). However, not all the layers built upon the biome's control layer need to refer to the control layer directly, as some layers can refer to each other, as long as the combined effect of the rules and layer references constrains the biome to the control layer in the way desired by the artist.

In embodiments, the control layer describes a location of a biome. A combination of control layers stitched together in a virtual area provides a combination of biomes that can populate a ‘super terrain’, as described above. Using and making biomes can quickly populate a super terrain with props and material and maintain consistency between super terrains.

Each control layer has a variety of rules associated with it that promulgate to layers dependent on, or controlled by, the control layer. Generation of a biome is now described using an example. The example should be interpreted in a non-limiting manner to generation of other types of biomes. In one embodiment, a semi-arid biome is created for a game such as for example, Warzone. A name, using a pre-specified naming convention, is allocated to the control layer. In the embodiment, the control layer is named SEMI_ARID_BIOME_BASE. This is the base layer of the biome and the one that controls painting of the entire biome if it is combined with other biomes. It is also what is left behind if all the other layers are removed or painted out. Therefore, if a biome is by itself on a terrain, the control or base layer may not be painted or edited or changed. Additionally, if this is one biome of several biomes defining a super terrain, then rather painting out the individual layers, this control or base layer defining the semi-arid biome is painted to make the entire biome show up or hide as required.

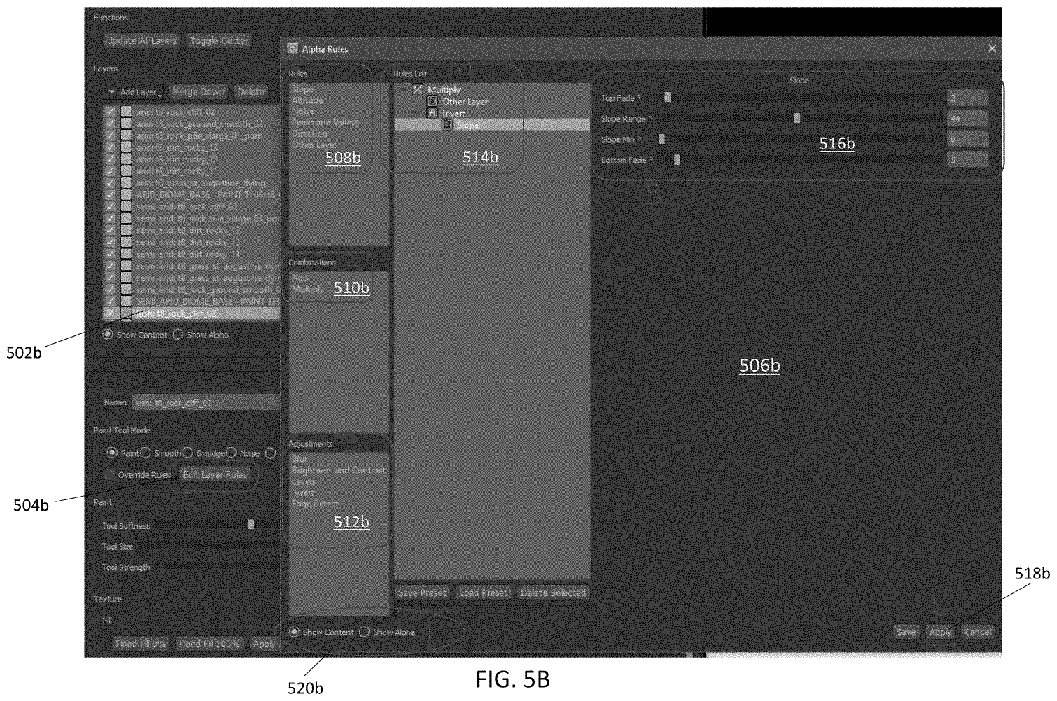

In the given example, the semi-arid biome is composed of material, height, and clutter layers. Each material and clutter layer follow a naming convention to keep things clear for the builders or game developer as they apply and work with the biome. In an example, each material or clutter layer has the name of the biome followed by a simple description of its clutter, or the name of the material. FIG. 5A illustrates examples of material, height and clutter layers listed for the semi-arid biome, in accordance with one embodiment of the present specification. The interface of FIG. 5A also illustrates buttons 502 that enable the developer to add and delete layers to and from the biome. Further, row 504 is used to identify material that constitutes the base layer of the biome. In a non-limiting example, the number 2 represents that there are at least two sets of rocky pebbles. In am embodiment, “POM” refers to parallax occlusion mapping, which is a graphics technique that allows for the material to appear more three-dimensional. Thus, the indications refer to the notion that in some embodiments, certain versions or portions of the material may have this technique applied, while other versions or portions do not.

Each layer has the ability to follow its own set of rules. In the example given above, each of the layers shown in the illustration of FIG. 5A is associated with its own set of rules. All of these layers work with each other based on a set of ‘alpha rules’. FIG. 5B illustrates an interface where a layer (lush: t8_rock_cliff_02) from FIG. 5A is selected to view and edit the rules associated with it, in accordance with some embodiments of the present specification. Referring to FIG. 5B, layer 502b is selected from a list of layers. The selection enables a button 504b, which can be activated to edit rules of the selected layer. Activating button 504b shows another interface 506b, which shows the rules, combinations, adjustments, among other details associated with the selected layer.

Rules 508b lists a basic set of alpha rules that can be applied to selected layer 502b. The rules may be combined, in embodiments, to generate an overall layout. Examples of the rules, listed in FIG. 5B, include Slope, Altitude, Noise, Peaks and Valleys, Direction, Other Layer. The rules for ‘Slope’ would establish a consistent slope that would apply to layers dependent on selected layer 502b. The rules for ‘Altitude’ would establish a range of heights or altitudes that would apply to layers dependent on selected layer 502b. The rules for ‘Noise’ would establish a consistent level of noise that would apply to layers dependent on selected layer 502b. The rules for ‘Peaks and Valleys’ would establish a layout of peaks and valleys that would apply to layers dependent on selected layer 502b. The rules for ‘Direction’ would establish a consistent direction of the selected layer that would decide the direction of layers dependent on selected layer 502b. The given parameters vary depending upon which rule is used. In some embodiments and examples, altitude is used for the altitude rule, while the noise rule includes a detail and scale parameter, slope includes minimum and maximum angles, and peaks and valleys includes “feature size”.

The rules corresponding to ‘Other Layer’ brings in the settings of another layer into the current layer 502b that is selected. Therefore, in embodiments, the rules using the ‘Other Layer’ reference, provides the data from any layer to another for use in defining the rules for that other layer. Therefore, rule propagation between different layers corresponding to a control layer of a biome is selective and optional since it is enabled by the use of the ‘Other Layer’ reference.

The ‘other layer’ references introduce a dependency between layer rules. A set of checks can be performed to ensure consistency between the different layers of a biome. If a layer A refers to layer B in its rules (through the ‘Other Layer’ reference), the result of rules of layer A cannot be computed until layer B's rule results are computed. Further, since all layers eventually refer to a base control layer, the control layer has no further dependencies and the set of rules for all layers built upon the control layer may be computed in an order of their dependency. However, it is possible for the artist to unintentionally make interdependencies between layers, in which case the checks may not be satisfied. In an example, layer A refers to layer B and layer B also refers to layer A, which would result in an error due to the interdependency. In this example, the artist is notified that there is an error that needs to be fixed, and the system computes the rule results in the order that the layers are listed, treating unsatisfied dependencies as empty results.

Combinations 510b may list the methods of combining different rules. In the illustration, the rules may be combined by any mathematical function, including ‘Add’ or ‘Multiply’ methods that enable addition and multiplication respectively. Further, adjustments 512b list the types of adjustments that may be performed on the selected layer. In some embodiments, the adjustments may include options to adjust: blur, brightness and contrast, levels, invert, and edge detect. The types of adjustments listed here are only exemplary and may include other types of adjustments as well.

A rules list window 514b provides an interface to the developer to drag a rule, combination, and/or adjustment from lists of rules 508b, combinations 510b, and adjustments 512b, and drop them in window 514b. The order of rules, their modes of combinations, and the types of adjustments are reflected by the sequence and hierarchy of the list created in window 514b. Therefore, in window 514b, one or more rules from rules 508b are listed, combined, and rearranged in the required format. In the illustrated example, ‘Other Layer’ and ‘Slope’ are multiplied together, and the Slope is Inverted. Similarly, each rule can be combined with another rule from rules 508b using a combiner from combinations 510b, and each rule can be modified using an adjustment from adjustments 512b.

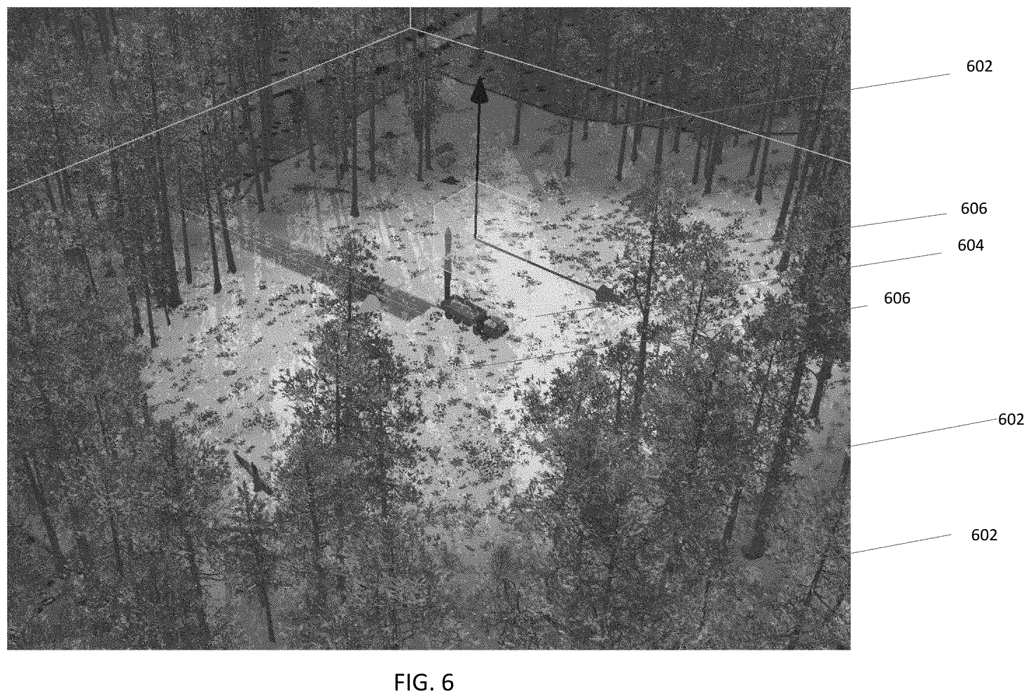

A rule setting window 516b enables setting of one or more parameters that are predefined for each rule. In the illustration of FIG. 5B, settings for ‘Slope’ are shown in window 516b since ‘Slope’ is selected under rules list window 514b. Among other possible parameters, the parameters that can be adjusted for ‘Slope’ include a top fade angle, slope range angle, a slope minimum angle, and a bottom fade angle. These parameters define the rules of ‘Slope’ for the selected layer 502b (in this case, lush: t8_rock_cliff_02) Similarly, parameters for other rules can be adjusted and/or defined through window 516b. The parameters defined in window 516b are applied to selected layer 502b by activating a button 518b, seen in the illustration at the bottom right corner of window 506b. Additionally, a toggle button 520b enables selection of a preview mask of how the defined rules are affecting selected layer 502b. The selection of “show alpha” enables a view that replaces the materials on the ground with a color coding showing the mask that is used. As an example, as shown in FIG. 6 (which is described in greater detail below), shaded areas 602 represent where the rules have been applied but are erased; shaded areas 604 are where the rules appear; and shaded areas 606 represent areas where the rules do not apply.

In practice, other types of layers, such as a clutter layer, material layer, among other types of layers, would use the same alpha rules (of the control layer). In one example, one rule of the control layer could be to not paint certain areas. This would mean that subsequent layers, such as clutter layers, would automatically adjust to not put objects or other materials on the “no-paint” areas. Furthermore, layers can depend on other layers, so a control layer can tell where clutter introduced by a dependent layer can be placed. The clutter layer can define what materials may be applied atop that layer. Therefore, the alpha rules fit together like Lego® pieces: paint the layer, tell the clutter where to go, and the clutter can tell what material it should be.

Control layers can be used by developers to control a biome's behavior. Such control layers overcome the need to provide a complete biome, and enable control of biome at different levels through the layers. In one embodiment, a layer with rule of “no trees” may be added to thin or to remove trees in a biome. In another embodiment, a layer with rule of “no large clutter” may be added to thin or to remove all large gameplay objects in any biome. The control layers described herein may be used as desired, and do not usually have to be painted fully in or fully out. FIG. 6 illustrates a location in a biome where a control layer with the rule ‘no large clutter’ is applied within an area of the biome that is otherwise filled with other types of clutter such as trees. Therefore control layers can be referenced by another layer as source data to perform operations on, extract portions of terrain (such as, for example, based on height), extract edges to put material around them, dither, and build upon the control layer in any other way.

Additionally, the presently described software system may be used to scalably apply clutter to one or more layers. In one embodiment, an algorithm for the application of clutter may be applied to one or more layers and applied in accordance with one or more of the aforementioned rules. To do so, a first plurality of points are randomly distributed throughout a layer. The first plurality of points are culled, moved or otherwise modified based on one or more of the aforementioned rules. A clutter type, such as a bush, rock, trash, grass, or other item, is selected and associated with one or more of the modified plurality of points. Clutter candidate placement points are generated with consideration of many small details. Artists have control over the spacing between the points, the rotation of the clutter at each point, and which model is picked for use at each point. The interaction with the rules is, however, much simpler. In embodiments, each candidate point is assigned a number between 0 and 1, essentially at random. If the value of the point is greater than the value of the rules at that location, clutter is placed at that candidate point, otherwise it is not. This has the effect of there being no clutter where rules are 0, maximally dense clutter where the rules are 1, and any value in between having clutter density proportionate to that value.

Multiple biome layers may be stitched together in a super-terrain. In other words, different biome layers may form different aspects of a super-terrain. In one embodiment, a super-terrain in a video game may include the following three biomes:

Biomes:PINES_MELTING_DENSE

Biome: PINES_MELTING

BIOME: PINES

The above embodiments of biome layers may be used to fill all non-traversable areas within a super-terrain. Each biome layer may be painted in the super-terrain such that they are 100% everywhere that biome is desired, and at areas where two different biome layers meet they overlap to some extent. The overlap of the biome layers ensures that the different layers blend with each other, thereby avoiding harsh transitions from one biome to another.

Height Map

Once terrains are created, they may have to be blended in order to be visually appealing. Embodiments of the present specification provide tools to dynamically and easily blend terrains, particularly when the terrains have different heights. The tools are preferably used offline to process the terrains, where each terrain is associated with a height map. A height map refers to a data representation of the height of a terrain at every point within the terrain. Conventionally, a height map is created by dividing terrains into a large number of grids. Those grids (for example, every four adjacent grids) are combined into a larger grid. The larger grid represents a combination of data which is simplified, and the simplified data is stored. Subsequently, four (or any other group of adjacent) large grids are combined to create a larger grid, for which data is further simplified and stored. The simplified data represents vertices within the grids. The conventional iterative process of combining grids and storing simplified data results in a large set of data with positioning of vertices at various detail levels. Interpolations are processed at runtime to use the stored data in the form of a height map.

In embodiments of the present specification, one or more simplified poly-reduced meshes are provided that capture terrains. Thus, data collapses between optimized meshes. In order to do so, the heightfield needs to be drawn at a high resolution near the camera and at progressively lower resolutions away from the camera. To accomplish this, the terrain is divided into a grid. Grid cells are merged four at a time into a nested hierarchy of grids, which is referred to as a quadtree. The number of triangles and vertices is roughly the same for each grid cell, regardless of its size, such that large cells store a lower resolution approximation of the terrain. The patches of terrain need to join seamlessly so that cracks are not visible in the terrain. This means that vertex positions along the grid boundaries have to be the same between neighboring patches. That is enforced by marking vertices along the boundary to be either kept in place or to be removed in an alternating pattern that is consistent between neighbors. The non-boundary vertices are allowed to be removed arbitrarily and their positions move freely during simplification so that they best match the shape of the terrain. The heightfield is interpolated between resolutions such that, as the camera moves, the terrain will morph to retain a high-resolution near the camera. The way this works is that the mesh simplifier keeps track of how vertices are merged together during simplification, and provides a many to one mapping from high-resolution input vertices to low-resolution output vertices. By interpolating the input vertices to output vertices according to that mapping, the terrain smoothly transitions between resolutions.

Blending of different terrains is accomplished by creating a blend layer that is defined by the height map of the varied terrains and a material rule, which could be defined by colors, textures, noise operations, drawing, blurring operations, concavity rules, among other types of rules. Embodiments of the present specification detect where edges of each terrain lie and then use a blend layer to blend inward from there. Therefore, in an example, blending may start at 100% at the edges of the terrains and then decreases as one moves away from the edges. Content of the blend layer mirrors contents of the neighboring terrains. In an example, while blending flat terrain and a bumpy terrain, the blend layer blends bumps into the flat terrain and flatness into the bumpy terrain.

In embodiments, the blending terrains may have different resolution of the corresponding meshes. The challenge of blending terrains comprising meshes of different resolutions may be overcome by using global settings, defined by a content creator or developer, to define density of the map. Therefore, different resolution terrains may be stitched next to each other and visually seamlessly blend using the blending tool at edges.

The above examples are merely illustrative of the many applications of the system of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

What is claimed is:

1. A method for generating a biome within a virtual landscape of a video game, wherein the biome comprises at least two layers, wherein the method comprises:
creating a first visual layer, wherein the first visual layer is defined by a set of first rules comprising a first plurality of visual characteristics; and
adding one or more second visual layers, wherein each of the one or more second visual layers is programmatically distinct from the first visual layer, wherein each of the one or more second visual layers automatically abides by each of the set of first rules, wherein each of the one or more second visual layers automatically adopts each of the first plurality of visual characteristics, and wherein the biome is made of a combination of the first layer and the one or more second visual layers.

2. The method of claim 1, wherein one of the set of first rules defines a location of the first visual layer.

3. The method of claim 1, wherein one of the set of first rules defines at least one of material, height, or clutter of the first visual layer.

4. The method of claim 1, wherein each of the one or more second visual layers is defined by a set of second rules, wherein the set of second rules is based upon and includes the set of first rules, wherein the second set of rules comprises a second plurality of visual characteristics and wherein the second plurality of visual characteristics is different from, but does not contradict, the first plurality of visual characteristics.

5. The method of claim 4, wherein the biome further comprises one or more third visual layers, wherein each of the one or more third visual layers is programmatically distinct from the first visual layer and the one or more second visual layers and wherein each of the one or more third visual layers automatically abides by each of the set of first rules and each of the set of second rules.

6. The method of claim 5, wherein each of the one or more third visual layers automatically adopts each of the first plurality of visual characteristics and the second plurality of visual characteristics and wherein the biome is made of a combination of the first layer, the one or more second visual layers, and the one or more third visual layers.

7. The method of claim 4, further comprising combining each of the set of first rules and each of the set of second rules using one or more functions.

8. The method of claim 7, wherein the one or more functions comprises addition and/or multiplication.

9. The method of claim 1, further comprising adjusting the first plurality of visual characteristics by performing at least one of a blurring function, an adjust brightness function and a contrast function, an invert function, or an edge detect function.

10. A system for generating a biome within a virtual landscape of a video game, wherein the biome comprises at least two layers, the system comprising a computing device programmed to execute a plurality of programmatic instructions that, when executed:
create a first visual layer, wherein the first visual layer is defined by a set of first rules comprising a first plurality of visual characteristics; and
add one or more second visual layers, wherein each of the one or more second visual layers is programmatically distinct from the first visual layer, wherein each of the one or more second visual layers automatically abides by each of the set of first rules, wherein each of the one or more second visual layers automatically adopts each of the first plurality of visual characteristics, and wherein the biome is made of a combination of the first layer and the one or more second visual layers.

11. The system of claim 10, wherein one of the set of first rules defines a location of the first visual layer.

12. The system of claim 10, wherein one of the set of first rules defines at least one of material, height, or clutter of the first visual layer.

13. The system of claim 10, wherein each of the one or more second visual layers is defined by a set of second rules, wherein the set of second rules is based upon and includes the set of first rules, wherein the second set of rules comprises a second plurality of visual characteristics and wherein the second plurality of visual characteristics is different from, but does not contradict, the first plurality of visual characteristics.

14. The system of claim 13, wherein the biome further comprises one or more third visual layers, wherein each of the one or more third visual layers is programmatically distinct from the first visual layer and the one or more second visual layers and wherein each of the one or more third visual layers automatically abides by each of the set of first rules and each of the set of second rules.

15. The system of claim 14, wherein each of the one or more third visual layers automatically adopts each of the first plurality of visual characteristics and the second plurality of visual characteristics and wherein the biome is made of a combination of the first layer, the one or more second visual layers, and the one or more third visual layers.

16. The system of claim 13, wherein, when executed, the plurality of programmatic instructions combine each of the set of first rules and each of the set of second rules using one or more functions.

17. The system of claim 16, wherein the one or more functions comprises addition and/or multiplication.

18. The system of claim 11, wherein, when executed, the plurality of programmatic instructions adjust the first plurality of visual characteristics by performing at least one of a blurring function, an adjust brightness function and a contrast function, an invert function, or an edge detect function.

19. The system of claim 13, wherein, when executed, the plurality of programmatic instructions adjust the second plurality of visual characteristics by performing at least one of a blurring function, an adjust brightness function and a contrast function, an invert function, or an edge detect function.
